(19) United States
(12) Patent Application Publication
(10) Pub. No.: US 2024/0176621 A1
(43) Pub. Date: May 30, 2024

(54) PROCESSOR

(71) Applicants: Preferred Networks, Inc., Tokyo (JP); NATIONAL UNIVERSITY CORPORATION KOBE UNIVERSITY, Hyogo (JP)

(72) Inventors: Hiroya KANEKO, Tokyo (JP); Ken NAMURA, Tokyo (JP); Tomoya ADACHI, Tokyo (JP); Junichiro MAKINO, Hyogo (JP)

(21) Appl. No.: 18/519,590

(22) Filed: Nov. 27, 2023

(30) Foreign Application Priority Data
Nov. 28, 2022 (JP) 2022-189517

(51) Int. Cl. G06F 9/30; G06F 9/38

(52) U.S. Cl. CPC G06F 9/3016; G06F 9/3001; G06F 9/3802

(57) ABSTRACT

A processor includes an instruction decoder configured to decode an instruction including bypass information and generate a bypass control signal based on the bypass information; a data holding circuit configured to hold data to be used to execute the instruction; an arithmetic circuit configured to execute the instruction and output operation result data; and a first selector configured to select the data held in the data holding circuit or the operation result data based on the bypass control signal and output the selected data or the selected operation result data to the arithmetic circuit.

### CROSS-REFERENCE TO RELATED APPLICATIONS

This patent application is based on and claims priority to Japanese Patent Application No. 2022-189517 filed on Nov. 28, 2022, the entire contents of which are incorporated herein by reference.

### TECHNICAL FIELD

The present disclosure relates to a processor.

### BACKGROUND

In a processor, a technique of improving the use efficiency of the arithmetic unit and improving the performance of the processor by, when operation result data obtained by an operation is used in a next operation, bypassing the operation result data before being stored in a register to an arithmetic unit and using the operation result data in the next operation is known.

This type of processor determines data dependency when an instruction held in an instruction queue is decoded, and determines whether the operation result data is bypassed to the arithmetic unit. The bypass of the operation result data needs to be performed between adjacent instructions, and when a bubble is present between instructions for which the bypass of the operation result data is performed, correct operation cannot be performed.

Additionally, when bypassing the operation result data to the arithmetic unit, the processor also stores the operation result data in the register. If the data stored in the register is not used in a subsequent operation, the use efficiency of the register may decrease and the processing performance of the processor may decrease.

### SUMMARY

A processor includes an instruction decoder configured to decode an instruction including bypass information and generate a bypass control signal based on the bypass information; a data holding circuit configured to hold data to be used to execute the instruction; an arithmetic circuit configured to execute the instruction and output operation result data; and a first selector configured to select the data held in the data holding circuit or the operation result data based on the bypass control signal and output the selected data or the selected operation result data to the arithmetic circuit.

### BRIEF DESCRIPTION OF THE DRAWINGS

FIG. 1 is a block diagram illustrating an example of a configuration of a processor according to an embodiment of the present invention;

FIG. 2 is an explanatory diagram illustrating an example of an instruction sequence executed by the processor illustrated in FIG. 1 and operation timings;

FIG. 3 is a block diagram illustrating an example of a configuration of a processor according to another embodiment of the present invention;

FIG. 4 is an explanatory diagram illustrating an example of an instruction sequence executed by the processor illustrated in FIG. 3 and operation timings;

FIG. 5 is a block diagram illustrating an example of a configuration of a processor according to another embodiment of the present invention;

FIG. 6 is a flowchart illustrating an example of operations of an instruction fetch unit of FIG. 5;

FIG. 7 is an explanatory diagram illustrating an example of the operations of the instruction fetch unit illustrated in FIG. 5;

FIG. 8 is a block diagram illustrating an example of a configuration of a processor according to another embodiment of the present invention;

FIG. 9 is a flowchart illustrating an example of operations of a bubble determination unit in FIG. 8;

FIG. 10 is a flowchart illustrating an example of the operations of an instruction fetch unit in FIG. 8;

FIG. 11 is an explanatory diagram illustrating an example of the operations of the instruction fetch unit in FIG. 8; and

FIG. 12 is a block diagram illustrating an example of a hardware configuration of a computer on which the processor illustrated in FIG. 1 is mounted.

### DETAILED DESCRIPTION OF EMBODIMENTS

In the following, embodiments of the present disclosure will be described in detail with reference to the drawings. Hereinafter, signal lines through which signals are transmitted are denoted by the same reference numerals as the names of the signals. Although not particularly limited, the processor described below may be mounted on a computer, such as a server, and may execute a program to perform a convolution operation or the like in training or inference of a deep neural network. Here, the processor described below may be used for scientific calculation or the like.

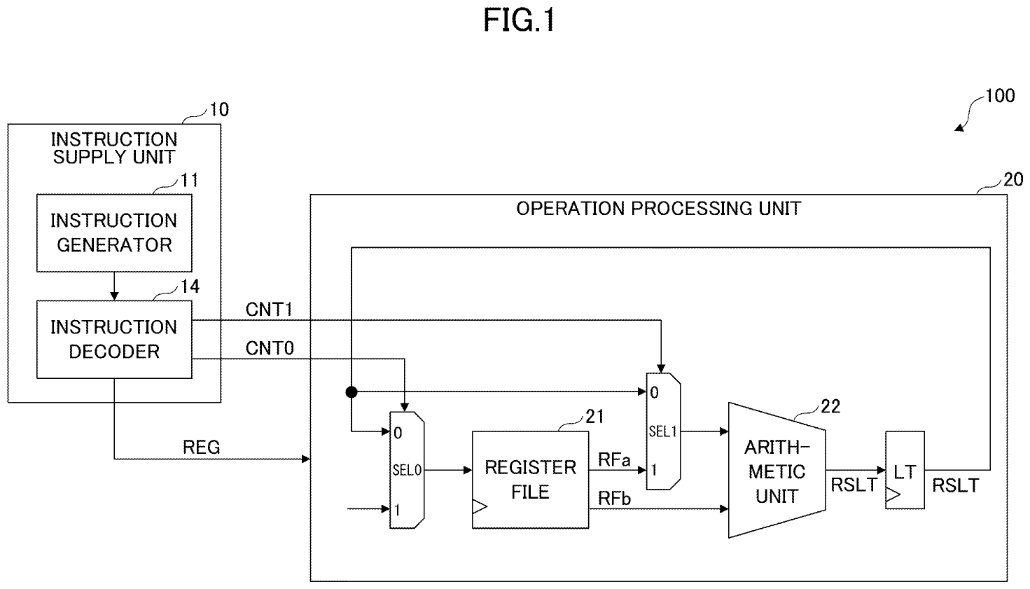

FIG. 1 is a block diagram illustrating an example of a configuration of a processor according to an embodiment of the present invention. A processor 100 illustrated in FIG. 1 may include an instruction supply unit 10 and an operation processing unit 20. The instruction supply unit 10 may include an instruction generator 11 and an instruction decoder 14. The operation processing unit 20 may include a register file 21, an arithmetic unit 22 (i.e., an arithmetic circuit 22), selectors SEL0 and SEL1, and a latch LT. The selector SEL0 is an example of a third selector, and the selector SEL1 is an example of a first selector. The processor 100 may operate in synchronization with a clock, but the description of the clock is omitted. For example, a triangle mark illustrated in the register file 21 and the latch LT indicates a clock input terminal.

Here, the processor 100 may include an instruction pipeline for processing multiple instructions in parallel in order to perform decoding processing, execution processing of an operation, storage processing of an operation result, and the like in multiple stages. However, the description of latches, registers, or the like for partitioning the stages is omitted except for the latch LT.

The instruction generator 11 may generate an instruction to be executed by the arithmetic unit 22 and supply the instruction to the instruction decoder 14. For example, the instruction generator 11 may include a memory, such as an instruction cache, including a memory unit in which an instruction is held and a control unit that controls reading of the instruction from the memory unit. Alternatively, the instruction generator 11 may include a data transfer circuit, such as a direct memory access controller (DMAC), that transfers an instruction held in a memory connected to the instruction supply unit 10 to the instruction decoder 14. Here, the instruction output from the instruction generator 11 may be supplied to the instruction decoder 14 via an instruction buffer.

In the present embodiment, an instruction set including instructions executable by the processor 100 includes, for example, a bypass operation instruction including a command to bypass, to the arithmetic unit 22, operation result data RSLT obtained by an operation of an immediately preceding instruction. The bypass operation instruction may include a command to prohibit the operation result data RSLT to be bypassed from being stored in the register file 21.

By explicitly instructing whether to perform the bypass by an instruction, a user or the like who uses the processor 100 can describe an instruction for bypassing the operation result data RSLT at an appropriate timing. Additionally, the instruction decoder 14 need not include a logic circuit that determines the data dependency based on the received instruction sequence and determines whether to bypass the operation result data RSLT based on a result of the determination. Therefore, the circuit scale of the instruction decoder 14 can be reduced, and the cost of the processor 100 can be reduced.

The instruction decoder 14 may decode the instruction supplied from the instruction generator 11, generate control signals CNT0 and CNT1, a register control signal REG, and the like according to control information and operand information included in the decoded instruction, and output the control signals CNT0 and CNT1, the register control signal REG, and the like to the operation processing unit 20. The control signal CNT0 may be used to control the selector SEL0, and the control signal CNT1 may be used to control the selector SEL1. The control signal CNT0 is an example of a selection control signal. The control signal CNT1 is an example of a bypass control signal.

When decoding an instruction including selection information, the instruction decoder 14 may generate the control signal CNT0 to be used to control the selector SEL0, based on the selection information. When decoding an instruction including bypass information, the instruction decoder 14 may generate the control signal CNT1 to be used to control the selector SEL1, based on the bypass information. For example, the bypass information is defined in a 2-bit region in the instruction, and a value (0 or 1) of one bit among the two bits corresponds to a state of CNT0 (a low level or a high level), and a value (0 or 1) of the other one bit corresponds to a state of CNT1 (a low level or a high level). When decoding an instruction including register information (operand information), the instruction decoder 14 may generate the register control signal REG to be used for reading from and writing to the register file 21, based on the register information.

The instruction decoded by the instruction decoder 14 may include the control information for directly controlling the selectors SEL0 and SEL1. Therefore, the user or the like who writes an instruction for operating the processor 100 can directly control, by the instruction including the control information, whether to perform the bypass processing of transferring the operation result data RSLT to the arithmetic unit 22 without the intervention of the register file 21. In other words, the user or the like who uses the processor 100 can instruct the processor 100 whether to perform the bypass processing by the instruction.

The register file 21 may include multiple registers, which are not illustrated, that hold operand data. Each of the registers may be selected by the register control signal REG. FIG. 1 illustrates, as an example, data RFa and RFb (source operands) respectively read from two registers of the register file 21. The register file 21 is an example of a data holding circuit that holds data used to execute the instruction.

When the control signal CNT0 is at the low level, the selector SEL0 selects the operation result data RSLT received at a terminal 0 and transfers it to the register file 21, for example. When the control signal CNT0 is at the high level, the selector SEL0 selects the operand received at a terminal 1 and transfers it to the register file 21, and prohibits the selection of the operation result data RSLT received at the terminal 0, for example. A register, in which data transferred from the selector SEL0 to the register file 21 is stored, is determined according to the register control signal REG.

The arithmetic unit 22 may be an adder, a multiplier, a logical arithmetic unit, or the like that executes the instruction decoded by the instruction decoder 14. Here, the operation processing unit 20 may include one or more units of multiple types of arithmetic units 22. When the operation processing unit 20 includes multiple arithmetic units 22, the selector SEL1 and the latch LT may be provided corresponding to each arithmetic unit 22, and different or identical control signals CNT1 may be generated corresponding to each selector SEL1.

An example in which the arithmetic unit 22 is an adder will be described below. The arithmetic unit 22 may receive the data transferred from the selector SEL1 at one input and may receive the data RFb output from the register file 21 at the other input. The arithmetic unit 22 adds the received data and outputs the result as the operation result data RSLT.

For example, the selector SEL1 selects the operation result data RSLT received at the terminal 0 when the control signal CNT1 is at the low level, selects the data RFa received at the terminal 1 when the control signal CNT1 is at the high level, and transfers the selected data to one input of the arithmetic unit 22. The operation result data RSLT transferred to the arithmetic unit 22 via the terminal 0 of the selector SEL1 is bypass data bypassed without the intervention of the register file 21.

The latch LT may latch the operation result data RSLT output from the arithmetic unit 22 and output the result to the selectors SEL0 and SEL1.

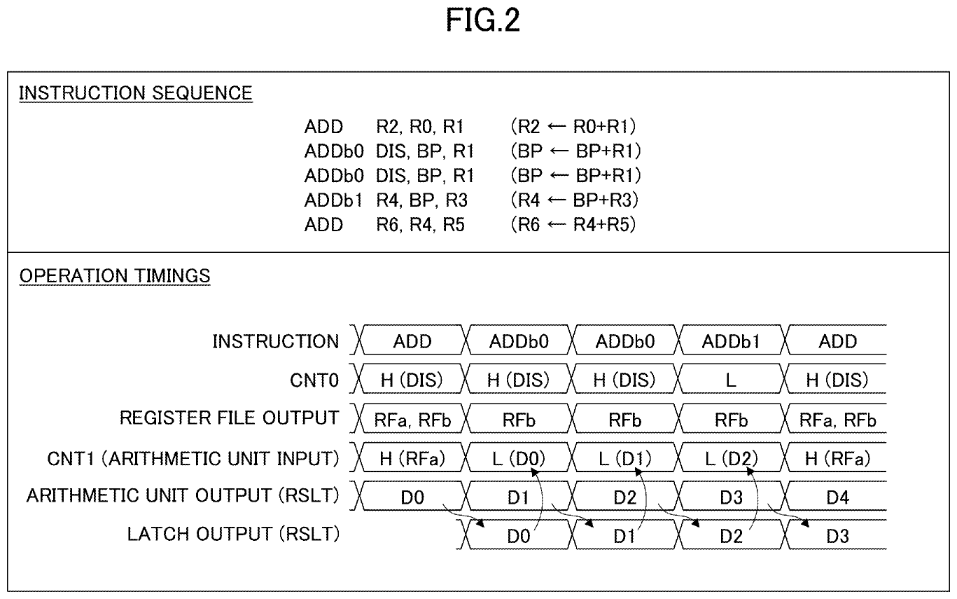

FIG. 2 is an explanatory diagram illustrating an example of an instruction sequence executed by the processor 100 illustrated in FIG. 2 and operation timings. In the example illustrated in FIG. 2, the processor 100 sequentially executes five add instructions ADD, ADDb0, ADDb0, ADDb1, and ADD. The operations of the add instructions ADD, ADDb0, ADDb0, and ADDb1 are respectively executed in one clock cycle.

In the add instruction ADD, values held in registers R0 and R1 (or R4 and R5) may be added by the arithmetic unit 22, and the addition result may be stored in a register R2 (or R6).

In the add instruction ADDb0, bypass data BP obtained by bypassing the addition result of the immediately preceding add instruction ADD and the data held in the register R1 may be added by the arithmetic unit 22. Additionally, in the add instruction ADDb0, the storing of the addition result in the register file 21 may be prohibited (DIS). The add instruction ADDb0 is the bypass operation instruction including the selection information for generating the high-level control signal CNT0 and the bypass information for generating the low-level control signal CNT1.

In the add instruction ADDb1, the bypass data BP obtained by bypassing the addition result of the immediately preceding add instruction and the data held in the register R3 may be added by the arithmetic unit 22, and the addition result may be stored in the register R4. The add instruction ADDb1 is a bypass operation instruction including selection information for generating the low-level control signal CNT0 and bypass information for generating the low-level control signal CNT1.

In the operation timings, when decoding the add instruction ADD, for example, the instruction decoder 14 may output the high-level control signals CNT0 and CNT1. With this, the selector SEL0 may select the terminal 1 to prohibit the input of the terminal 0 (DIS). The selector SEL1 may select the input 1 (the data RFa).

When decoding the add instruction ADDb0, the instruction decoder 14 may output the high-level control signal CNT0 and the low-level control signal CNT1. With this, the selector SEL0 may select the terminal 1 to prohibit the input of the terminal 0 (DIS). The selector SEL1 may select the terminal 0 (the data DO or the data D1, which is the bypass data BP).

When decoding the add instruction ADDb1, the instruction decoder 14 may output the low-level control signals CNT0 and CNT1. With this, the selector SEL0 may select the terminal 0 and transfer an addition result D2 of the immediately preceding add instruction ADDb0 to the register R4. The selector SEL1 may select the terminal 0 (the data D2, which is the bypass data BP).

As described above, in the present embodiment, the instruction decoder 14 decodes the instruction including the bypass information for directly controlling the selector SEL1, and outputs the control signal CNT1 for controlling the selector SEL1. This allows the user or the like who describes the instruction for operating the processor 100 to directly instruct the processor 100, by the instruction, whether to bypass the operation result data RSLT. The processor 100 operates based on the control signal CNT1 generated by the decoding of the instruction decoder 14, so that the bypass processing can be normally performed, and the use efficiency of the arithmetic unit 22 can be improved.

The instruction decoder 14 may decode the instruction including the selection information for directly controlling the selector SEL0 and output the control signal CNT0 for controlling the selector SEL0. This can prevent the operation result data RSLT bypassed by the arithmetic unit 22 from being stored in the register file 21. For example, when multiple operations, in which the bypass of the operation result data RSLT is repeated, are executed, the bypass data in the middle of the operations can be prevented from being stored in the register file 21. This can suppress a decrease in the use efficiency of the registers in the register file 21 and suppress a decrease in the processing performance of the processor 100.

Additionally, the instruction decoder 14 need not include a logic circuit that determines the data dependency based on the received instruction sequence and determines whether to bypass the operation result data RSLT based on a result of the determination. Therefore, the circuit scale of the instruction decoder 14 can be reduced, and the cost of the processor 100 can be reduced. For example, when the time required for the decode processing of the instruction decoder 14 can be shortened, the processing performance of the processor 100 can be further improved.

As described above, when the user or the like who uses the processor 100 explicitly gives an instruction to bypass data with an instruction, a decrease in the processing performance of the processor 100 can be suppressed by performing the bypass of the data normally.

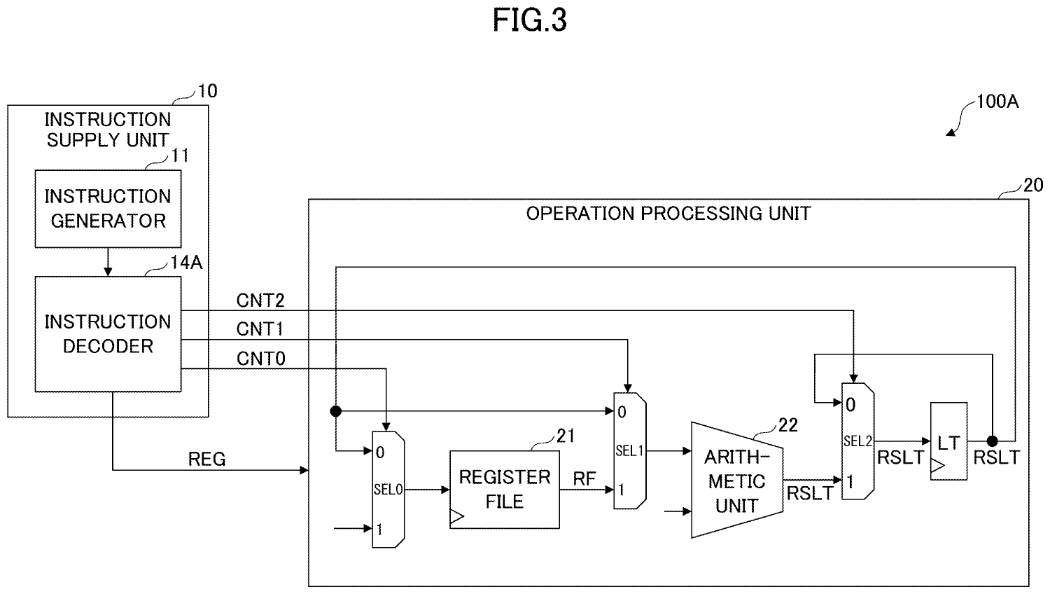

FIG. 3 is a block diagram illustrating an example of a configuration of a processor according to another embodiment of the present disclosure. Elements substantially the same as those in FIG. 1 are denoted by the same reference symbols and will not be described in detail. A processor 100A illustrated in FIG. 3 has the same configuration as the processor 100 of FIG. 1 except that the processor 100A may include an instruction decoder 14A instead of the instruction decoder 14, and the selector SEL2 may be arranged between the arithmetic unit 22 and the latch LT. The selector SEL2 is an example of a second selector.

In the selector SEL2, a terminal 0 may be connected to an output of the latch LT and a terminal 1 may be connected to an output of the arithmetic unit 22. The selector SEL2 may select the operation result data RSLT output from the latch LT when the control signal CNT2 is at the low level, and may select the operation result data RSLT output from the arithmetic unit 22 when the control signal CNT2 is at the high level. This allows the selector SEL2 to continue to select the output of the latch LT and hold the operation result data RSLT while receiving the low level control signal CNT2.

In addition to the function of the instruction decoder 14 illustrated in FIG. 1, the instruction decoder 14A may have a function of generating a control signal CNT2 used to control the selector SEL2 according to whether a bubble occurs between instructions causing the bypass of the operation result data RSLT. For example, the instruction decoder 14A generates the low level control signal CNT2 when detecting that a bubble occurs before an instruction that uses the bypassed operation result data RSLT of the immediately preceding instruction. The control signal CNT2 is an example of a hold control signal.

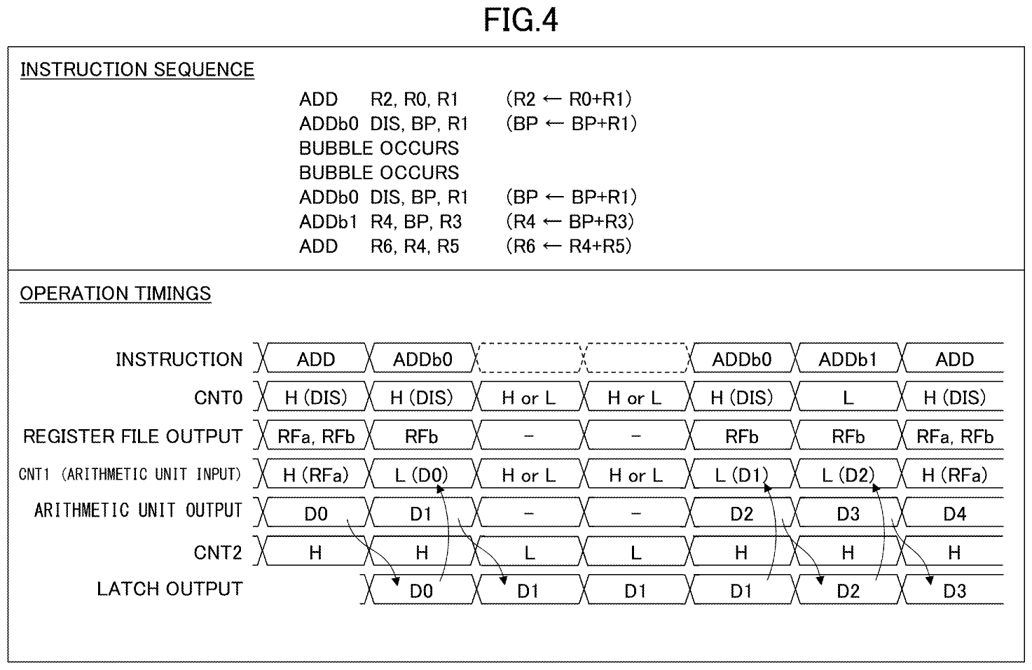

FIG. 4 is an explanatory diagram illustrating an example of an instruction sequence executed by the processor 100A illustrated in FIG. 3 and operation timings. Detailed description of operations substantially the same as those in FIG. 2 will be omitted. In the example illustrated in FIG. 4, the processor 100A may sequentially execute the add instructions ADD, ADDb0, ADDb0, ADDb1, and ADD as in FIG. 2. Hereinafter, the add instruction ADDb0 executed next to the first add instruction ADD is referred to as the second add instruction ADDb0.

In the example illustrated in FIG. 4, a bubble occurs in two clock cycles between the second add instruction ADDb0, which is a preceding instruction, and the third add instruction ADDb0, which is a subsequent instruction. When detecting that the bubble occurs immediately before the add instruction ADDb0, the instruction decoder 14A may output the low level control signal CNT2 for an insertion cycle of the bubble. Here, the instruction decoder 14A may output the high-level control signal CNT2 except when the generation of the bubble is detected immediately before the add instruction ADDb0.

The operations of the processor 100A when the add instructions ADD, ADDb0 and ADDb1 are decoded are substantially the same as the operations illustrated in FIG. 2. While receiving the low level control signal CNT2, the selector SEL2 may hold the operation result data RSLT of the second add instruction ADDb0 and output the held operation result data RSLT to the latch LT. This allows the operation to be correctly executed without failure in the operation processing unit 20, even when a bubble occurs between an instruction for generating the operation result data RSLT to be bypassed and an instruction for using the operation result data RSLT that is bypassed.

As described above, also in the present embodiment, as in the above-described embodiment, the bypass information added to the instruction can instruct the processor 100A whether to bypass the operation result data RSLT. This allows the processor 100A to normally perform the bypass processing, and the use efficiency of the arithmetic unit 22 can be improved.

Further, in the present embodiment, the processor 100A may include the instruction decoder 14A that detects a bubble generated between instructions causing the bypass of the operation result data RSLT (i.e., between an instruction for generating the operation result data RSLT to be bypassed and an instruction for using the operation result data RSLT that is bypassed) to output the control signal CNT2, and the selector SEL2 for holding the operation result data RSLT in accordance with the control signal CNT2. This can execute the operation correctly without failure, even when a bubble occurs between instructions causing the bypass of the operation result data RSLT.

As a result, when the user who uses the processor 100A explicitly gives an instruction to bypass data, a decrease in the processing performance of the processor 100A can be suppressed by performing the bypass of the data normally.

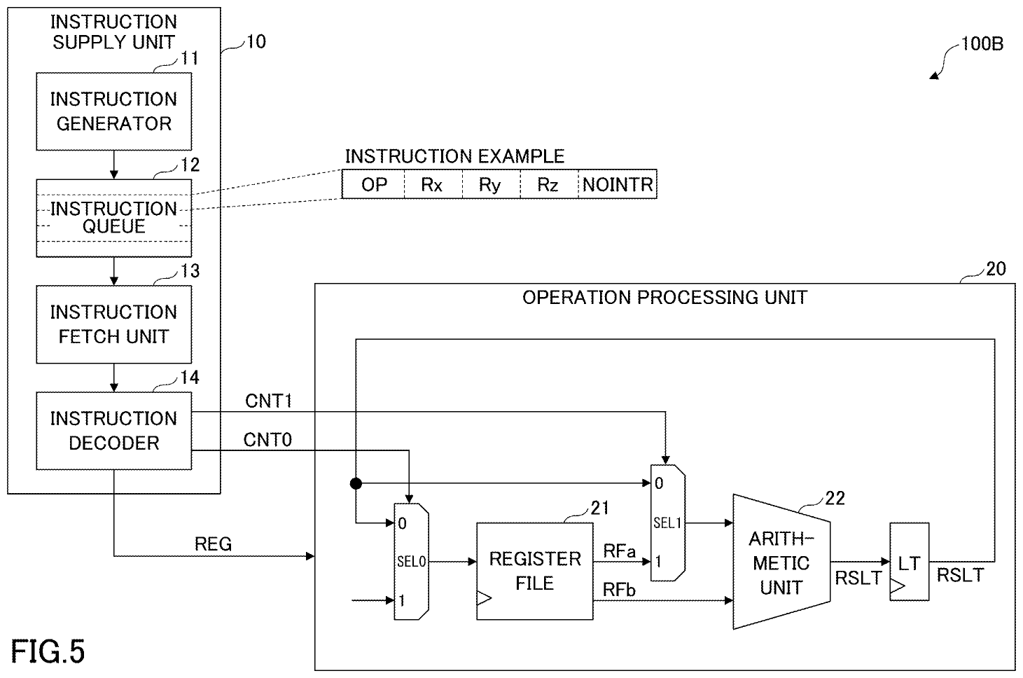

FIG. 5 is a block diagram illustrating an example of a configuration of a processor according to another embodiment of the present disclosure. Elements substantially the same as those in FIG. 1 are denoted by the same reference symbols and detailed description thereof will be omitted. A processor 100B illustrated in FIG. 5 may include an instruction queue 12 and an instruction fetch unit 13 (i.e., an instruction fetch circuit 13) arranged between the instruction generator 11 and the instruction decoder 14. The operation processing unit 20 may be the same as the operation processing unit 20 of FIG. 1 or may be the same as the operation processing unit 20 of FIG. 3. When the operation processing unit 20 is the same as the operation processing unit 20 of FIG. 3, the instruction supply unit 10 may include the instruction decoder 14A of FIG. 3 instead of the instruction decoder 14.

The instruction queue 12 may be a first-in first-out (FIFO) queue including multiple entries, and may sequentially hold instructions output from the instruction generator 11 in the entries. For example, the instructions held in the instruction queue 12 may include an instruction code OP, operands Rx, Ry, and Rz, and bubble insertion prohibition information NOINTR.

For example, the instruction code OP includes identification codes of the add instructions ADD, ADDb0, and ADDb1 illustrated in FIG. 2 and FIG. 4. The operands Rx, Ry, and Rz indicate register numbers of the register file 21. The number of operands Rx, Ry, and Rz included in each instruction is not limited to three, and may be more than three or less than three.

The bubble insertion prohibition information NOINTR is set to a logical value indicating that the insertion of the bubble is prohibited (for example, “1”) when a target instruction executes an operation using bypass data of an instruction (i.e., a preceding instruction) executed immediately before the target instruction in the instruction pipeline. The bubble insertion prohibition information NOINTR is set to a logical value indicating that the insertion of the bubble is permitted (for example, “0”) when a target instruction can execute an operation even when the target instruction is executed two or more clock cycles after the preceding instruction is executed.

When the bubble insertion prohibition information NOINTR included in a fetch target instruction from the instruction queue 12 indicates that the bubble insertion is prohibited, the instruction fetch unit 13 may fetch the target instruction and supply it to the instruction decoder 14. When the bubble insertion prohibition information NOINTR included in the fetch target instruction from the instruction queue 12 indicates that the bubble insertion is permitted, the instruction fetch unit 13 may determine whether to fetch the target instruction according to the amount of instructions held in the instruction queue 12.

For example, when the amount of instructions held in the instruction queue 12 is less than a first threshold value VT1, the instruction fetch unit 13 may supply the no-operation instruction NOP to the instruction decoder 14 until the amount of instructions held in the instruction queue 12 becomes greater than or equal to the first threshold value VT1. When the amount of instructions held in the instruction queue 12 is greater than or equal to the first threshold value VT1, the instruction fetch unit 13 may fetch the fetch target instruction from the instruction queue 12 and supply it to the instruction decoder 14.

The first threshold value VT1 may be set to be greater than or equal to the maximum number of consecutive instructions that require the bypass of the operation result data RSLT. That is, the user or the like who uses the processor 100B may describe instructions (a program) so that the number of consecutive instructions that require the bypass of the operation result data RSLT becomes less than or equal to than the number of instructions indicated by the first threshold value VT1.

Here, bubble insertion prohibition information NOINTR included in a subsequent instruction for executing an operation by using operation result data RSLT of a preceding instruction as the bypass data may be set to the prohibition of the bubble insertion. Bubble insertion prohibition information NOINTR included in a subsequent instruction for executing an operation without bypassing operation result data RSLT of a preceding instruction may be set to the permission of the bubble insertion.

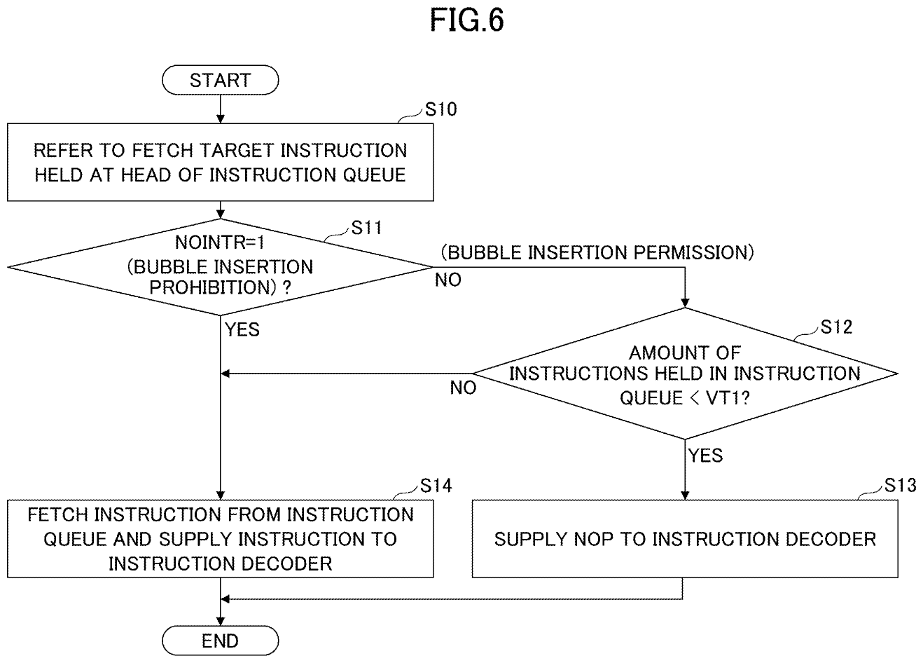

FIG. 6 is a flowchart illustrating an example of operations of the instruction fetch unit 13 illustrated in FIG. 5. The flow illustrated in FIG. 6 may be started before the instruction is fetched each time the instruction fetch unit 13 fetches the instruction from the instruction queue 12.

First, in step S10, the instruction fetch unit 13 may refer to the fetch target instruction held in the head entry of the instruction queue 12. Next, in step S11, the instruction fetch unit 13 may determine whether the bubble insertion prohibition information NOINTR included in the fetch target instruction indicates “1”. The instruction fetch unit 13 may perform step S14 when the bubble insertion prohibition information NOINTR indicates “1” (the prohibition of the bubble insertion), and may perform step S12 when the bubble insertion prohibition information NOINTR indicates “0” (the permission of the bubble insertion).

In step S12, the instruction fetch unit 13 may perform step S13 when the amount of instructions held in the instruction queue 12 is less than the first threshold value VT1, and may perform step S14 when the amount of instructions held in the instruction queue 12 is greater than or equal to the first threshold value VT1.

In step S13, the instruction fetch unit 13 may supply the no-operation instruction NOP to the instruction decoder 14 without fetching the fetch target instruction from the instruction queue 12, and end the process illustrated in FIG. 6.

As described above, when the amount of instructions held in the instruction queue 12 is small, the instruction fetch unit 13 may supply the no-operation instruction NOP to the instruction decoder 14. This can prevent the instruction queue 12 from becoming empty even when multiple instructions indicating that the bubble insertion is prohibited are sequentially fetched from the instruction queue 12. As a result, when the operation for bypassing the operation result data RSLT is repeatedly executed, the bubble can be prevented from being inserted due to the instruction queue 12 becoming empty, and data can be prevented from being destroyed due to the bypass of the data not being normally performed.

In step S14, the instruction fetch unit 13 may fetch the fetch target instruction from the instruction queue 12 and supply it to the instruction decoder 14, and end the process illustrated in FIG. 6. For example, the instruction fetch unit 13 fetches the fetch target instruction indicating that the bubble insertion is prohibited from the instruction queue 12 and supplies the fetch target instruction to the instruction decoder 14, so that the arithmetic unit 22 can continuously execute operations of an instruction immediately before the fetch target instruction and the fetch target instruction.

This can correctly execute the operation without generating a bubble between instructions causing the bypass of the operation result data RSLT. Additionally, when a predetermined amount or more of instructions are held in the instruction queue 12, the instruction queue 12 can be prevented from overflowing by sequentially fetching the instructions from the instruction queue 12 and supplying the instructions to the instruction decoder 14.

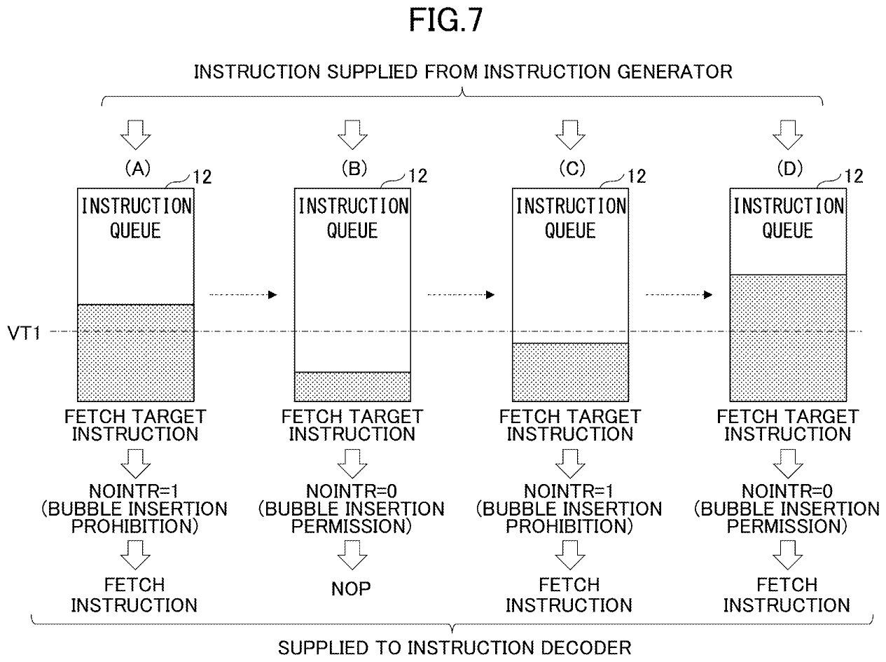

FIG. 7 is an explanatory diagram illustrating an example of operations of the instruction fetch unit 13 illustrated in FIG. 5. A shaded area in the instruction queue 12 indicates a relative amount of instructions held by the instruction queue 12. The amount of instructions held by the instruction queue 12 increases when the amount of instructions supplied from the instruction generator 11 is greater than the amount of instructions fetched by the instruction fetch unit 13. The amount of instructions held by the instruction queue 12 decreases when the amount of instructions supplied from the instruction generator 11 is less than the amount of instructions fetched by the instruction fetch unit 13.

In the states (A) and (C), when the bubble insertion prohibition information NOINTR included in the fetch target instruction to be fetched from the instruction queue 12 is “1” (the prohibition of the bubble insertion), the instruction fetch unit 13 may fetch the fetch target instruction and supply it to the instruction decoder 14 regardless of the amount of instructions held in the instruction queue 12.

In the state (B), the instruction fetch unit 13 may supply the no-operation instruction NOP to the instruction decoder 14 when the bubble insertion prohibition information NOINTR included in the fetch target instruction is “0” (the permission of the bubble insertion) in conjunction with when the number of instructions held in the instruction queue 12 is less than the threshold value VT1.

In the state (B), the fetch target instruction is not fetched from the instruction queue 12. By the operation in the state (B), the amount of instructions held in the instruction queue 12 can be increased. This can prevent a bubble from being inserted due to the instruction queue 12 becoming empty, in the operation of the state (C), even when the instruction causing the bypass of the operation result data RSLT continues.

In the state (D), when the bubble insertion prohibition information NOINTR included in the fetch target instruction is “0” (the permission of the bubble insertion) and the number of instructions held in the instruction queue 12 is greater than or equal to the threshold value VT1, the instruction fetch unit 13 may fetch the fetch target instruction and supply it to the instruction decoder 14. This can prevent the instruction queue 12 from overflowing.

As described above, also in the present embodiment, as in the above-described embodiment, the bypass information added to the instruction can instruct the processor 100B whether to bypass the operation result data RSLT. This allows the processor 100B to normally perform the bypass processing, and the use efficiency of the arithmetic unit 22 can be improved. Additionally, because the logic circuit for determining the bypass of the operation result data RSLT becomes unnecessary, the circuit scale of the instruction decoder 14 can be reduced and the cost of the processor 100B can be reduced.

Furthermore, in the present embodiment, when the bubble insertion prohibition information NOINTR indicates the prohibition of the bubble insertion, the instruction fetch unit 13 fetches the instruction from the instruction queue 12 and supplies it to the instruction decoder 14. This allows the operation result data RSLT of the preceding instruction to be bypassed and used for the operation of the succeeding instruction, and the operation can be executed by bypassing the data normally.

When the bubble insertion prohibition information NOINTR indicates that the bubble insertion is permitted, the instruction fetch unit 13 may determine whether to fetch the instruction and supply it to the instruction queue 12 or to supply the no-operation instruction NOP to the instruction queue 12 in accordance with the amount of instructions held in the instruction queue 12. This can prevent the instruction queue 12 from becoming empty even when multiple instructions indicating that the bubble insertion is prohibited are sequentially fetched from the instruction queue 12.

As a result, when the user who uses the processor 100 explicitly instructs the bypass of the data and the operation causing the bypass of the operation result data RSLT is repeatedly executed, the bubble can be prevented from being inserted due to the instruction queue 12 becoming empty. This can prevent data from being destroyed due to the bypass of the data not being normally performed, and can suppress a decrease in the processing performance of the processor 100B. Additionally, when a predetermined amount or more of instructions are held in the instruction queue 12, the instruction queue 12 can be prevented from overflowing by sequentially fetching the instructions from the instruction queue 12 and supplying the instructions to the instruction decoder 14.

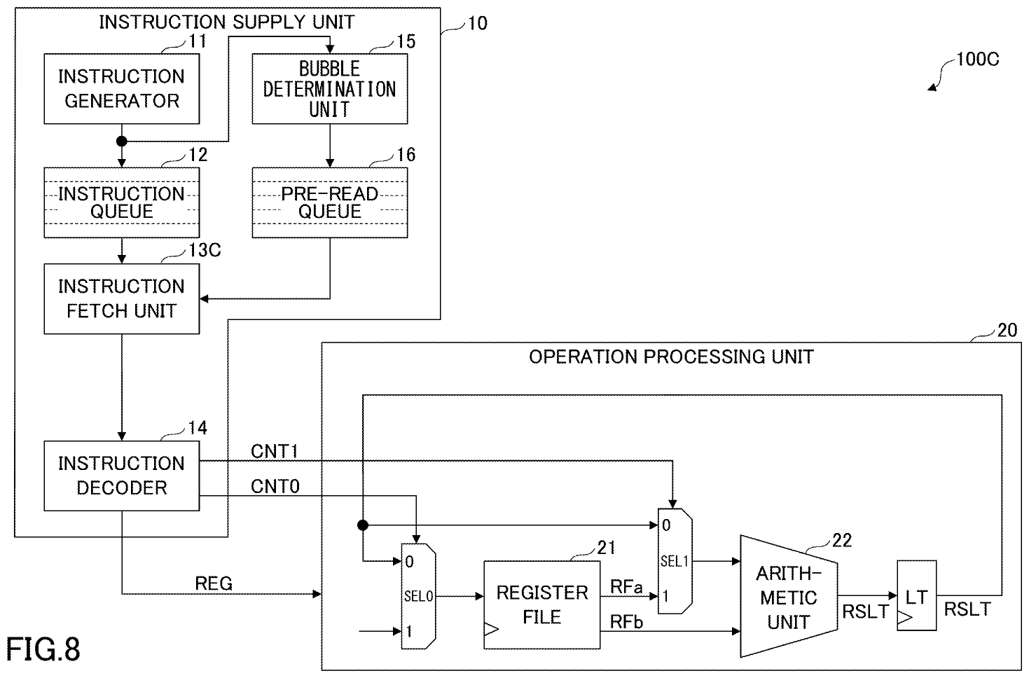

FIG. 8 is a block diagram illustrating an example of a configuration of a processor according to another embodiment of the present disclosure. Elements substantially the same as those in FIG. 1 and FIG. 5 are denoted by the same reference symbols and detailed description thereof will be omitted. A processor 100C illustrated in FIG. 8 may have the same configuration as the processor 100B illustrated in FIG. 5 except that the processor 100C illustrated in FIG. 8 includes an instruction fetch unit 13C instead of the instruction fetch unit 13 illustrated in FIG. 5, and a bubble determination unit 15 (i.e., a determination circuit 15) and a pre-read queue 16 are added to the instruction supply unit 10. The operation processing unit 20 of FIG. 8 may be the same as the operation processing unit 20 of FIG. 3. When the operation processing unit 20 of FIG. 8 is the same as the operation processing unit 20 of FIG. 3, the instruction supply unit 10 may include the instruction decoder 14A of FIG. 3 instead of the instruction decoder 14.

The bubble determination unit 15 may pre-read the instruction supplied from the instruction generator 11 to the instruction queue 12. Here, the instructions held in the instruction queue 12 need not include the bubble insertion prohibition information NOINTR illustrated in FIG. 5. The bubble determination unit 15 may determine whether the operation of the pre-read instruction to be executed by the arithmetic unit 22 is executed using the bypass data of the operation result data RSLT of the instruction executed immediately before the pre-read instruction. Thus, the bubble determination unit 15 includes an instruction holding unit, which is not illustrated, that holds information on multiple instructions pre-read in the past.

When it is determined that the operation of the pre-read instruction is executed by using the bypass data, the bubble determination unit 15 may store a flag “1” in an entry of the pre-read queue 16 corresponding to an entry of the instruction queue 12 in which the pre-read instruction is stored. The flag “1” indicates that the bubble insertion between the pre-read instruction and an instruction immediately before the pre-read instruction in the instruction pipeline is prohibited. The flag “1” is an example of use information indicating that the operation result data RSLT bypassed from the arithmetic unit 22 is used.

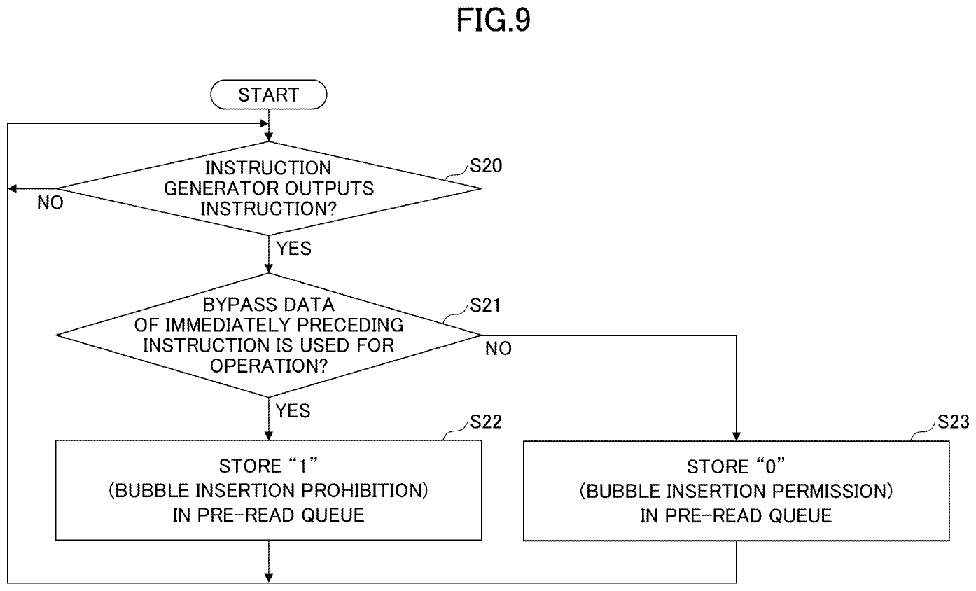

When it is determined that the operation of the pre-read instruction is executed without using the bypass data, the bubble determination unit 15 may store a flag “O” in the entry of the pre-read queue 16 corresponding to the entry of the instruction queue 12 in which the pre-read instruction is stored. The flag “O” indicates that the bubble insertion between the pre-read instruction and the instruction immediately before the pre-read instruction in the instruction pipeline is permitted. The flag “O” is an example of non-use information indicating that the operation result data RSLT bypassed from the arithmetic unit 22 is not used. Here, the logical values “1” and “0” of the flag indicating the use information and the non-use information may be set inversely. An example of the operations of the bubble determination unit 15 is illustrated in FIG. 9.

The pre-read queue 16 is, for example, a FIFO queue including entries equal in number to or different in number from the number of the entries of the instruction queue 12. The pre-read queue 16 and the instruction queue 12 are updated in conjunction with each other. For example, for the pre-read queue 16 and the instruction queue 12, a common head pointer and a common tail pointer may be used to store and retrieve information.

In the instruction queue 12, valid instructions may be held from an entry indicated by the head pointer to an entry indicated by the tail pointer. Similarly, in the pre-read queue 16, valid flags may be held from an entry indicated by the head pointer to an entry indicated by the tail pointer. In the following, in the instruction queue 12 and the pre-read queue 16, the entry indicated by the head pointer is also referred to as a head entry, and the entry indicated by the tail pointer is also referred to as a tail entry.

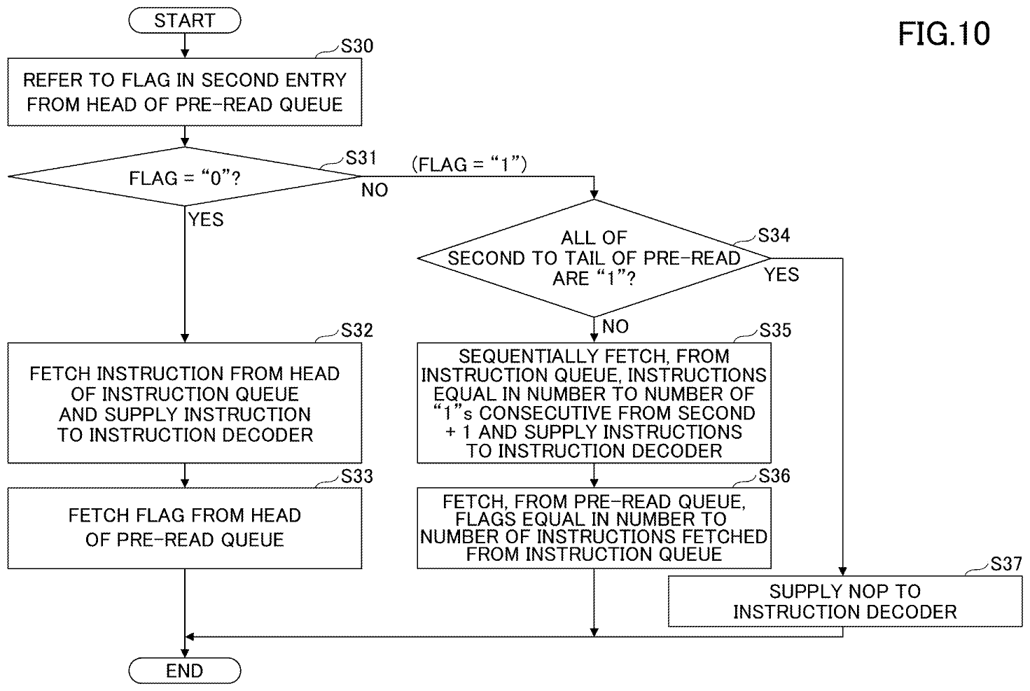

The instruction fetch unit 13C may determine whether to fetch the instruction held in the instruction queue 12 in accordance with the value of the flag held in the pre-read queue 16. When it is determined that the instruction is to be fetched, the instruction fetch unit 13C may fetch the instruction from the instruction queue 12 and supply it to the instruction decoder 14. When it is determined that the instruction is not to be fetched, the instruction fetch unit 13C may supply the no-operation instruction NOP to the instruction decoder 14. An example of operations of the instruction fetch unit 13C is illustrated in FIG. 10.

FIG. 9 is a flowchart illustrating an example of the operations of the bubble determination unit 15 of FIG. 8. The flow illustrated in FIG. 9 is started, for example, when the processor 100C is activated. First, in step S20, the bubble determination unit 15 may wait for an output of an instruction from the instruction generator 11, and perform step S21 when the instruction is output from the instruction generator 11.

In step S21, the bubble determination unit 15 may determine whether a determination target instruction output from the instruction generator 11 is to be executed by using data obtained by bypassing an operation result of an instruction executed immediately before the determination target instruction. The bubble determination unit 15 may perform step S22 when the determination target instruction is to be executed by using the bypass data of the operation result of the instruction executed immediately before. The bubble determination unit 15 may perform step S23 when the determination target instruction does not use the bypass data of the operation result of the instruction executed immediately before.

In step S22, the bubble determination unit 15 may store “1” indicating that the bubble insertion is prohibited in the entry of the pre-read queue 16 corresponding to the entry of the instruction queue 12 in which the determination target instruction is stored, and may end the operations illustrated in FIG. 9. In step S23, the bubble determination unit 15 may store “0” indicating that the bubble insertion is permitted in the entry of the pre-read queue 16 corresponding to the entry of the instruction queue 12 in which the determination target instruction is stored, and may end the operations illustrated in FIG. 9.

FIG. 10 is a flowchart illustrating an example of operations of the instruction fetch unit 13C in FIG. 8. The flow illustrated in FIG. 10 may be started before the instruction is fetched each time the instruction fetch unit 13C fetches the instruction from the instruction queue 12.

First, in step S30, the instruction fetch unit 13C may refer to the flag held in the second entry, which is an entry next to the head entry indicated by the head pointer in the pre-read queue 16. Here, when the flag is held only in the head entry of the pre-read queue 16, because the flag is not present in the second entry, the operation illustrated in FIG. 10 need not be performed and a bubble may be inserted in the operation processing unit.

Next, in step S31, when the flag referred to in step S30 is “0”, the instruction fetch unit 13C may perform step S32, and when the flag is not “0” (that is, when the flag is “1”), the instruction fetch unit 13C may perform step S34.

In step S32, the instruction fetch unit 13C may fetch the instruction held in the head entry of the instruction queue 12 and supply it to the instruction decoder 14. Next, in step S33, the instruction fetch unit 13C may fetch the flag from the head entry of the pre-read queue 16 and end the operations illustrated in FIG. 10.

Here, the states of the instruction queue 12 and the pre-read queue 16 may be updated in conjunction with each other by the operations of steps S32 and S33. Additionally, when an instruction is stored in the instruction queue 12, a flag is also stored in the pre-read queue 16, so that the states of the instruction queue 12 and the pre-read queue 16 may be updated in conjunction with each other.

In step S34, the instruction fetch unit 13C may determine whether all the flags held from the second entry to the tail entry in the pre-read queue 16 are “1”. When all the flags from the second entry to the tail entry are “1”, the instruction fetch unit 13C may perform step S37, and when at least one of the flags from the second entry to the tail entry is “0”, the instruction fetch unit 13C may perform step S35.

In step S35, the instruction fetch unit 13C may sequentially fetch, from the instruction queue 12, instructions equal in number to the number obtained by adding “1” (i.e., the head entry) to the number of the entries continuously holding the flag “1” from the second entry of the pre-read queue 16, and supply the instructions to the instruction decoder 14.

Here, the flag “1” need not continue, and may be only one. That is, the flag “1” of the second entry may be sandwiched between the flag “0” of the head entry and the flag “0” of the third entry. In other words, the instruction fetch unit 13C may sequentially fetch the instruction held from the head entry holding the flag “0” to an entry immediately before an entry in which the flag “0” appears next to the head entry, and may supply the instruction to the instruction decoder 14.

Next, in step S36, the instruction fetch unit 13C may fetch, from the pre-read queue 16, the flags equal in number to the number of instructions fetched from the instruction queue 12, discard the flags, and end the operations illustrated in FIG. 10.

In step S37, the instruction fetch unit 13C may supply the no-operation instruction NOP to the instruction decoder 14 without using the instruction queue 12 and the pre-read queue 16, and may end the operations illustrated in FIG. 10. Subsequently, until the flag “0” is stored in the tail entry of the pre-read queue 16, steps S30, S31, S34, and S37 may be repeatedly performed, and the no-operation instruction NOP may be sequentially supplied to the instruction decoder 14.

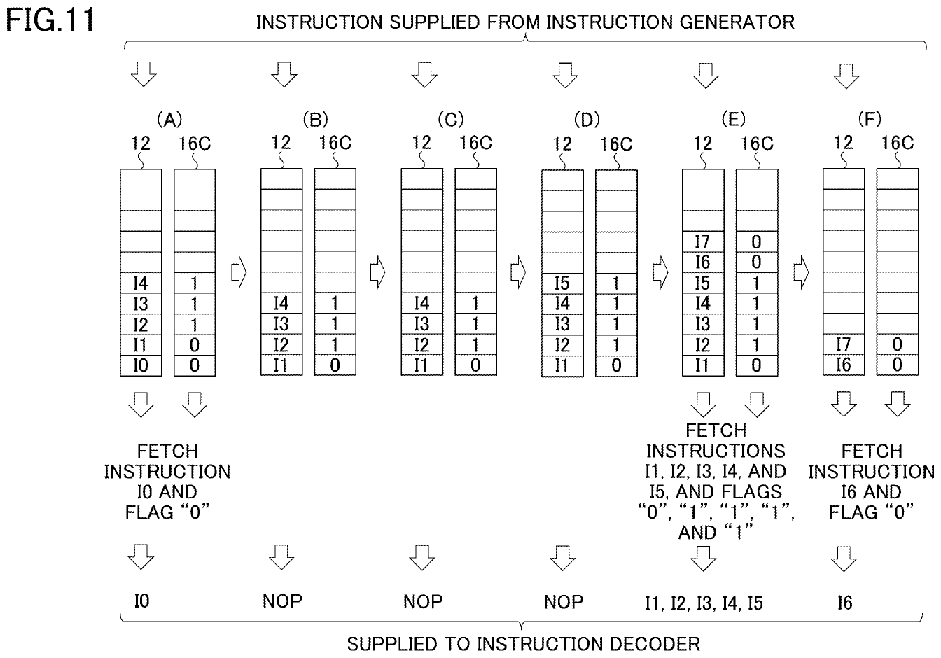

FIG. 11 is an explanatory diagram illustrating an example of operations of the instruction fetch unit 13C in FIG. 8. In the instruction queue 12, symbols I0-I7 indicate instructions stored in the entries. In the pre-read queue 16, “0” and “1” indicate values of the flag. In the instruction queue 12 and the pre-read queue 16, a blank entry indicates that the entry is empty. In FIG. 11, an entry of the instruction queue 12 holding the instruction with the smaller number and a corresponding entry of the pre-read queue 16 are the head entries.

The instructions I2-I5 held in the instruction queue 12 corresponding to the entries holding the flag “1” are bypass operation instructions including a command to bypass the operation result data RSLT of the operation of the immediately preceding instruction to the arithmetic unit 22.

In the state (A), the instruction queue 12 holds the instructions I0 to I4, and the flags held by the pre-read queue 16 that correspond to the instructions I0 to I4 are “0”, “0”, “1”, “1”, and “1” in order from the head entry.

Because the flag of the second entry is “0”, the instruction fetch unit 13C may fetch the instruction 10 from the head entry of the instruction queue 12 and supply it to the instruction decoder 14. Additionally, the instruction fetch unit 13C may fetch the flag “0” from the head entry of the pre-read queue 16 and discard it.

Next, in the state (B), the instruction fetch unit 13C may determine that all the flags from the second entry to the tail entry of the pre-read queue 16 are “1”. Therefore, the instruction fetch unit 13C may supply the no-operation instruction NOP to the instruction decoder 14 without fetching the instruction from the instruction queue 12.

Next, in the state (C), because all the flags from the second entry to the last entry of the pre-read queue 16 are “1”, the instruction fetch unit 13C may supply the no-operation instruction NOP to the instruction decoder 14 without fetching the instruction from the instruction queue 12.

Next, in the state (D), a new instruction I5 may be supplied from the instruction generator 11 to the instruction queue 12. The bubble determination unit 15 may determine that the instruction 15 is executed using the bypass data of the operation result of the immediately preceding instruction 14 by the arithmetic unit 22. Therefore, the bubble determination unit 15 may store the flag “1” in the entry of the pre-read queue 16 that correspond to the entry at the tail of the instruction queue 12.

As in the state (B), because all the flags from the second entry to the tail entry of the pre-read queue 16 are “1”, the instruction fetch unit 13C may supply the no-operation instruction NOP to the instruction decoder 14 without fetching the instruction from the instruction queue 12.

When all the flags from the second entry to the tail entry of the pre-read queue 16 are “1”, the fetching of the instruction from the instruction queue 12 is prevented, so that the fetching of all the instructions for executing the operation using the bypass data from the instruction queue 12 can be prevented.

This can prevent a second instruction for executing an operation by using bypass data of an operation result of a first instruction from being stored in the instruction queue 12 after the first instruction is fetched from the instruction queue 12, for example. As a result, a bubble can be prevented from being inserted between the first instruction and the second instruction, and the operation of the second instruction can be prevented from not being executed normally.

Next, in the state (E), new instructions I6 and I7 are supplied from the instruction generator 11 to the instruction queue 12. The bubble determination unit 15 may determine that the instructions I6 and I7 are executed without using the bypass results of the respective immediately preceding instructions I5 and I6 by the arithmetic unit 22. Therefore, the bubble determination unit 15 may store the flags “0” in two entries of the pre-read queue 16 that correspond to the two entries of the instruction queue 12 in which the instructions I6 and I7 are held.

The instruction fetch unit 13C may determine that the second flag of the pre-read queue 16 is “1” and any one of the third and subsequent flags of the pre-read queue 16 is “0”. That is, the instruction fetch unit 13C may determine that the flag “0” is stored after the flag “1” continuously held from the second entry.

Thus, the instruction fetch unit 13C may fetch five instructions I1 to I5 held in the instruction queue 12 that correspond to entries from the entry of the head of the pre-read queue 16 to the last entry holding the flag “1”, and sequentially supply the instructions I1 to I5 to the instruction decoder 14. Additionally, the instruction fetch unit 13C may fetch and discard the flags from the five entries of the pre-read queue 16 that correspond to the five entries of the instruction queue 12 from which the instructions I1 to I5 have been fetched.

Next, in the state (F), as in the state (A), because the flag of the second entry is “0”, the instruction fetch unit 13C may fetch the instruction 16 from the head entry of the instruction queue 12 and supply it to the instruction decoder 14. Additionally, the instruction fetch unit 13C may fetch the flag “0” from the head entry of the pre-read queue 16 and discard it.

After the instruction 16 is fetched from the instruction queue 12, only the instruction 17 may be held in the instruction queue 12, and only the flag “0” corresponding to the instruction 17 may be held in the pre-read queue 16. At this time, because the flag of the second entry is not present in step S30 of FIG. 10, the instruction fetch unit 13C may prevent the instruction 17 from being fetched from the instruction queue 12.

As described above, in the present embodiment, the bypass information added to the instruction can instruct the processor 100C whether the operation result data RSLT is bypassed, as in the above-described embodiments. This allows the processor 100C to normally perform the bypass processing, and the use efficiency of the arithmetic unit 22 can be improved.

Furthermore, in the present embodiment, the bubble determination unit 15 and the pre-read queue 16 enable the instruction fetch unit 13C to determine whether to bypass the operation result data RSLT of the immediately preceding instruction and use the operation result data RSLT for the operation of the fetch target instruction, and can execute the operation by normally bypassing the data. That is, in the present embodiment, without the bubble insertion prohibition information NOINTR illustrated in FIG. 5 being included in the instruction, the bypass of the data is normally performed to suppress a decrease in the processing performance of the processor 100C.

Additionally, when one or more flags “1” sandwiched between the flag “0” of the head entry and the flag “O” of the entry on the tail side are present, the instruction fetch unit 13C fetches the instructions held from the head entry to the entry corresponding to the last flag “1” in the instruction queue 12 and supplies the instructions to the instruction decoder 14. The instructions corresponding to the flags “1” sandwiched between the flags “0” are collectively and sequentially supplied to the instruction decoder 14, thereby eliminating the need for managing the amount of instructions held in the instruction queue 12 as described with reference to FIG. 7.

As described above, when the user who uses the processor 100C explicitly instructs the bypass of the data by the instruction, the bypass of the data is normally performed to suppress a decrease in the processing performance of the processor 100C.

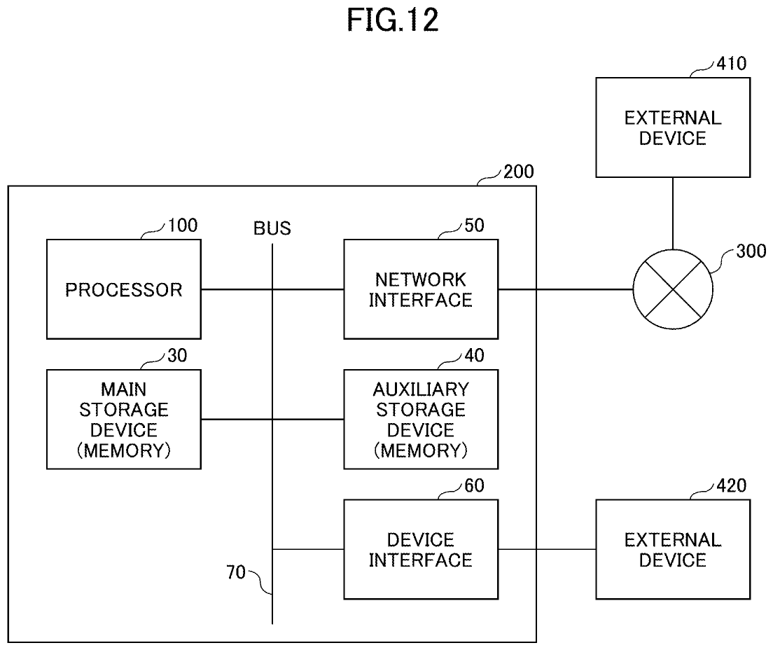

FIG. 12 is a block diagram illustrating an example of a hardware configuration of a computer on which the processor 100 illustrated in FIG. 1 is mounted. In FIG. 12, as an example, the computer may be realized as a computer 200 including a processor 100, a main storage device 30 (a memory), an auxiliary storage device 40 (a memory), a network interface 50, and a device interface 60, which are connected to each other via a bus 70. Here, the computer 200 may include the processor 100A illustrated in FIG. 3, the processor 100B illustrated in FIG. 5, or the processor 100C illustrated in FIG. 8, instead of the processor 100.

The computer 200 of FIG. 12 includes one of each component, but may include two or more of the same components. Additionally, although one computer 200 is illustrated in FIG. 12, software may be installed in multiple computers, and each of the multiple computers may execute the same part or different parts of the processing of the software. In this case, a form of distributed computing in which the computers communicate with each other via the network interface 50 or the like to perform the processing may be employed. That is, a system may be configured to implement functions by one or more computers 200 executing instructions stored in one or more storage devices. Additionally, the information transmitted from a terminal may be processed by one or more computers 200 provided on a cloud, and the processing result may be transmitted to the terminal.

Various operations may be executed in parallel processing using one or more processors 100 mounted on the computer 200 or using multiple computers 200 via a network. Additionally, various operations may be distributed to multiple arithmetic cores in the processor 100 to be executed in parallel processing. Additionally, some or all of the processes, means, and the like of the present disclosure may be realized by at least one of a processor or a storage device provided on a cloud that can communicate with the computer 200 via a network. As described, each device in the above-described embodiments may be in a form of parallel computing by one or more computers.

The processor 100 may be an electronic circuit (a processing circuit, processing circuitry, a CPU, a GPU, an FPGA, an ASIC, or the like) that performs at least one of computer control or operations. Additionally, the processor 100 may be any of a general-purpose processor, a dedicated processing circuit designed to execute a specific operation, and a semiconductor device including both a general-purpose processor and a dedicated processing circuit. Additionally, the processor 100 may include an optical circuit or may include an arithmetic function based on quantum computing.

The processor 100 may perform arithmetic processing based on data or software input from each device or the like of the internal configuration of the computer 200, and may output an arithmetic result or a control signal to each device or the like. The processor 100 may control respective components constituting the computer 200 by executing an operating system (OS), an application, or the like of the computer 200.

The main storage device 30 may store instructions executed by the processor 100, various data, and the like, and information stored in the main storage device 30 may be read by the processor 100. The auxiliary storage device 40 is a storage device other than the main storage device 30. Here, these storage devices indicate any electronic components capable of storing electronic information, and may be semiconductor memories. The semiconductor memory may be either a volatile memory or a nonvolatile memory. A storage device for storing various data and the like in the computer 200 may be realized by the main storage device 30 or the auxiliary storage device 40, or may be realized by a built-in memory built in the processor 100.

When the computer 200 includes at least one storage device (memory) and at least one processor 100 connected (coupled) to the at least one storage device, the at least one processor 100 may be connected to one storage device. Additionally, at least one storage device may be connected to one processor 100. Additionally, a configuration in which at least one processor 100 among the multiple processors 100 is connected to at least one storage device among the multiple storage devices may be included. Additionally, this configuration may be realized by storage devices and the processors 100 included in multiple computers 200. Furthermore, a configuration in which the storage device is integrated with the processor 100 (for example, an L1 cache or a cache memory including an L2 cache) may be included.

The network interface 50 is an interface for connecting to the communication network 300 by wire or wirelessly. As the network interface 50, an appropriate interface, such as one conforming to an existing communication standard, may be used. The network interface 50 may exchange information with an external device 410 connected via the communication network 300. Here, the communication network 300 may be any one of a wide area network (WAN), a local area network (LAN), a personal area network (PAN), and the like, or a combination thereof, as long as information is exchanged between the computer 200 and the external device 410. Examples of the WAN include the Internet and the like, and examples of the LAN include IEEE802.11, Ethernet (registered trademark), and the like. Examples of the PAN include Bluetooth (registered trademark), Near Field Communication (NFC), and the like.

The device interface 60 is an interface, such as a USB, that is directly connected to an external device 420.

The external device 410 is a device connected to the computer 200 via a network. The external device 420 is a device directly connected to the computer 200.

The external device 410 or the external device 420 may be, for example, an input device. The input device is, for example, a device, such as a camera, a microphone, a motion capture device, various sensors, a keyboard, a mouse, a touch panel, or the like, and gives acquired information to the computer 200. Alternatively, the device may be a device including an input unit, a memory, and a processor, such as a personal computer, a tablet terminal, or a smartphone.

Additionally, the external device 410 or the external device 420 may be, for example, an output device. The output device may be, for example, a display device, such as a liquid crystal display (LCD) or an organic electro luminescence (EL) panel, or may be a speaker that outputs sound or the like. Alternatively, the device may be a device including an output unit, a memory, and a processor, such as a personal computer, a tablet terminal, or a smartphone.

Additionally, the external device 410 or the external device 420 may be a storage device (a memory). For example, the external device 410 may be a network storage or the like, and the external device 420 may be a storage, such as an HDD.

Additionally, the external device 410 or the external device 420 may be a device having some functions of the components of the computer 200. That is, the computer 200 may transmit a part or all of the processing result to the external device 410 or the external device 420, or may receive a part or all of the processing result from the external device 410 or the external device 420.

In the present specification (including the claims), if the expression “at least one of a, b, and c” or “at least one of a, b, or c” is used (including similar expressions), any one of a, b, c, a-b, a-c, b-c, or a-b-c is included. Multiple instances may also be included in any of the elements, such as a-a, a-b-b, and a-a-b-b-c-c. Further, the addition of another element other than the listed elements (i.e., a, b, and c), such as adding d as a-b-c-d, is included.

In the present specification (including the claims), if the expression such as “in response to data being input”, “using data”, “based on data”, “according to data”, or “in accordance with data” (including similar expressions) is used, unless otherwise noted, a case in which the data itself is used and a case in which data obtained by processing the data (e.g., data obtained by adding noise, normalized data, a feature amount extracted from the data, and intermediate representation of the data) is used are included. If it is described that any result can be obtained “in response to data being input”, “using data”, “based on data”, “according to data”, or “in accordance with data” (including similar expressions), unless otherwise noted, a case in which the result is obtained based on only the data is included, and a case in which the result is obtained affected by another data other than the data, factors, conditions, and/or states may be included. If it is described that “data is output” (including similar expressions), unless otherwise noted, a case in which the data itself is used as an output is included, and a case in which data obtained by processing the data in some way (e.g., data obtained by adding noise, normalized data, a feature amount extracted from the data, and intermediate representation of the data) is used as an output is included.

In the present specification (including the claims), if the terms “connected” and “coupled” are used, the terms are intended as non-limiting terms that include any of direct, indirect, electrically, communicatively, operatively, and physically connected/coupled. Such terms should be interpreted according to a context in which the terms are used, but a connected/coupled form that is not intentionally or naturally excluded should be interpreted as being included in the terms without being limited.

In the present specification (including the claims), if the expression “A configured to B” is used, a case in which a physical structure of the element A has a configuration that can perform the operation B, and a permanent or temporary setting/configuration of the element A is configured/set to actually perform the operation B may be included. For example, if the element A is a general purpose processor, the processor may have a hardware configuration that can perform the operation B and be configured to actually perform the operation B by setting a permanent or temporary program (i.e., an instruction). If the element A is a dedicated processor, a dedicated arithmetic circuit, or the like, a circuit structure of the processor may be implemented so as to actually perform the operation B irrespective of whether the control instruction and the data are actually attached.

In the present specification (including the claims), if a term indicating inclusion or possession (e.g., “comprising”, “including”, or “having”) is used, the term is intended as an open-ended term, including inclusion or possession of an object other than a target object indicated by the object of the term. If the object of the term indicating inclusion or possession is an expression that does not specify a quantity or that suggests a singular number (i.e., an expression using “a” or “an” as an article), the expression should be interpreted as being not limited to a specified number.

In the present specification (including the claims), even if an expression such as “one or more” or “at least one” is used in a certain description, and an expression that does not specify a quantity or that suggests a singular number (i.e., an expression using “a” or “an” as an article) is used in another description, it is not intended that the latter expression indicates “one”. Generally, an expression that does not specify a quantity or that suggests a singular number (i.e., an expression using “a” or “an” as an article) should be interpreted as being not necessarily limited to a particular number.

In the present specification, if it is described that a particular advantage/result is obtained in a particular configuration included in an embodiment, unless there is a particular reason, it should be understood that that the advantage/result may be obtained in another embodiment or other embodiments including the configuration. It should be understood, however, that the presence or absence of the advantage/result generally depends on various factors, conditions, and/or states, and that the advantage/result is not necessarily obtained by the configuration. The advantage/result is merely an advantage/result that is obtained by the configuration described in the embodiment when various factors, conditions, and/or states are satisfied, and is not necessarily obtained in the invention according to the claim that defines the configuration or a similar configuration.

In the present specification (including the claims), if multiple hardware performs predetermined processes, each of the hardware may cooperate to perform the predetermined processes, or some of the hardware may perform all of the predetermined processes. Additionally, some of the hardware may perform some of the predetermined processes while other hardware may perform the remainder of the predetermined processes. In the present specification (including the claims), if an expression such as “one or more hardware perform a first process and the one or more hardware perform a second process” is used, the hardware that performs the first process may be the same as or different from the hardware that performs the second process. That is, the hardware that performs the first process and the hardware that performs the second process may be included in the one or more hardware. The hardware may include an electronic circuit, a device including an electronic circuit, or the like.

In the present specification (including the claims), if multiple storage devices (memories) store data, each of the multiple storage devices (memories) may store only a portion of the data or may store an entirety of the data. Additionally, a configuration in which some of the multiple storage devices store data may be included.

Although the embodiments of the present disclosure have been described in detail above, the present disclosure is not limited to the individual embodiments described above. Various additions, modifications, substitutions, partial deletions, and the like can be made without departing from the conceptual idea and spirit of the invention derived from the contents defined in the claims and the equivalents thereof. For example, in the embodiments described above, if numerical values or mathematical expressions are used for description, they are presented as an example and do not limit the scope of the present disclosure. Additionally, the order of respective operations in the embodiments is presented as an example and does not limit the scope of the present disclosure.

What is claimed is:

1. A processor comprising:
an instruction decoder configured to decode an instruction including bypass information and generate a bypass control signal based on the bypass information;
a data holding circuit configured to hold data to be used to execute the instruction;
an arithmetic circuit configured to execute the instruction and output operation result data; and
a first selector configured to select the data held in the data holding circuit or the operation result data based on the bypass control signal and output the selected data or the selected operation result data to the arithmetic circuit.

2. The processor as claimed in claim 1, further comprising:
a latch configured to hold the operation result data; and
a second selector arranged between an output of the arithmetic circuit and the latch and configured to connect the output of the arithmetic circuit or an output of the latch to an input of the latch based on a hold control signal,
wherein the instruction decoder generates the hold control signal for an insertion cycle of a bubble, in response to detecting that the bubble is inserted between a preceding instruction and a subsequent instruction to be executed using the operation result data bypassed from the arithmetic circuit based on an execution of the preceding instruction.

3. The processor as claimed in claim 1, further comprising:
an instruction queue configured to hold the instruction; and
an instruction fetch circuit configured to fetch the instruction held in the instruction queue and supply the instruction to the instruction decoder,
wherein the instruction held in the instruction queue further includes bubble insertion prohibition information indicating that an insertion of the bubble between a preceding instruction immediately before the instruction and the instruction in an instruction pipeline is prohibited or permitted,
wherein the instruction fetch circuit fetches and supplies the instruction to the instruction decoder, in response to detecting that the bubble insertion prohibition information included in the instruction fetched from the instruction queue indicates that the insertion of the bubble is prohibited, and
wherein the instruction fetch circuit determines whether to fetch and supply the instruction to the instruction decoder or to supply a no-operation instruction to the instruction decoder in accordance with an amount of instructions held in the instruction queue, in response to detecting that the bubble insertion prohibition information included in the instruction indicates that the insertion of the bubble is permitted.

4. The processor as claimed in claim 3, wherein, in response to detecting that the bubble insertion prohibition information included in the instruction indicates that the insertion of the bubble is permitted,
the instruction fetch circuit supplies a no-operation instruction to the instruction decoder until the amount of the instructions held in the instruction queue becomes greater than or equal to a first threshold value upon detecting the amount of the instructions held in the instruction queue is less than the first threshold value, and
the instruction fetch circuit fetches the instruction from the instruction queue and supplies the instruction to the instruction decoder upon detecting the amount of the instructions held in the instruction queue becomes greater than or equal to the first threshold value.

5. The processor as claimed in claim 3,
wherein the bubble insertion prohibition information included in the instruction for executing an operation by using the operation result data bypassed from the arithmetic circuit via the first selector is set to indicate that the insertion of the bubble is prohibited, and
wherein the bubble insertion prohibition information included in the instruction for executing an operation without using the operation result data bypassed from the arithmetic circuit is set to indicate that the insertion of the bubble is permitted.

6. The processor as claimed in claim 1, further comprising:
an instruction queue configured to hold an instruction;
an instruction fetch circuit configured to fetch the instruction held in the instruction queue and supply the instruction to the instruction decoder;
a determination circuit configured to determine whether an operation of the instruction supplied to the instruction queue is executed by the arithmetic circuit using the operation result data bypassed from the arithmetic circuit via the first selector; and
a pre-read queue configured to hold a determination result of the determination circuit corresponding to the instruction held in the instruction queue and configured to be updated in response to the instruction queue being updated,
wherein the instruction fetch circuit supplies a no-operation instruction to the instruction decoder in response to detecting that a head entry of the pre-read queue holds non-use information indicating that the operation result data bypassed from the arithmetic circuit is not used, in conjunction with detecting that all of second and subsequent entries of the pre-read queue hold use information indicating that the operation result data bypassed from the arithmetic circuit is used, and subsequently, in response to detecting that the non-use information is stored in an entry after the second and subsequent consecutive entries of the pre-read queue in which the use information is continuously held, sequentially supplies instructions held in the instruction queue corresponding to the use information held in the head entry and the second and subsequent consecutive entries of the pre-read queue to the instruction decoder.

7. The processor as claimed in claim 6, wherein the instruction fetch circuit supplies the instruction held in the head entry of the instruction queue to the instruction decoder in response to detecting that the second entry of the pre-read queue holds the non-use information.

8. The processor as claimed in claim 1, further comprising a third selector configured to select the data to be used in the instruction supplied from the instruction decoder or the operation result data output from the arithmetic circuit based on a selection control signal and output the selected data or selected operation result data to the data holding circuit,
wherein the instruction decoded by the instruction decoder further includes selection information, and
wherein the instruction decoder generates the selection control signal based on the selection information.

9. The processor as claimed in claim 8, wherein the instruction including the bypass information for causing the first selector to select the operation result data includes the selection information for prohibiting the operation result data from being selected by the third selector.

10. The processor as claimed in claim 1, wherein the instruction decoder generates a signal including a command to prohibit the operation result data to be bypassed from being stored in the data holding circuit.

11. A processing method comprising:
decoding, by an instruction decoder, an instruction including bypass information and generate a bypass control signal based on the bypass information;
holding, by a data holding circuit, data to be used to execute the instruction;
executing, by an arithmetic circuit, the instruction and outputting, by the arithmetic circuit executing the instruction, operation result data;
selecting, by a first selector, the data held in the data holding circuit or the operation result data based on the bypass control signal; and
outputting, by the first selector, the selected data or the selected operation result data to the arithmetic circuit.

12. The processing method as claimed in claim 11, further comprising:
holding, by a latch, the operation result data; and
connecting, by a second selector arranged between an output of the arithmetic circuit and the latch, the output of the arithmetic circuit or an output of the latch to an input of the latch based on a hold control signal,
wherein the instruction decoder generates the hold control signal for an insertion cycle of a bubble, in response to detecting that the bubble is inserted between a preceding instruction and a subsequent instruction to be executed using the operation result data bypassed from the arithmetic circuit based on an execution of the preceding instruction.

13. The processing method as claimed in claim 11, further comprising:
holding, by an instruction queue, the instruction; and
fetching, by an instruction fetch circuit, the instruction held in the instruction queue and supplying, by the instruction fetch circuit, the instruction to the instruction decoder,
wherein the instruction held in the instruction queue further includes bubble insertion prohibition information indicating that an insertion of the bubble between a preceding instruction immediately before the instruction and the instruction in an instruction pipeline is prohibited or permitted,
wherein the instruction fetch circuit fetches and supplies the instruction to the instruction decoder, in response to detecting that the bubble insertion prohibition information included in the instruction fetched from the instruction queue indicates that the insertion of the bubble is prohibited, and
wherein the instruction fetch circuit determines whether to fetch and supply the instruction to the instruction decoder or to supply a no-operation instruction to the instruction decoder in accordance with an amount of instructions held in the instruction queue, in response to detecting that the bubble insertion prohibition information included in the instruction indicates that the insertion of the bubble is permitted.

14. The processing method as claimed in claim 13, wherein, in response to detecting that the bubble insertion prohibition information included in the instruction indicates that the insertion of the bubble is permitted,
the instruction fetch circuit supplies a no-operation instruction to the instruction decoder until the amount of the instructions held in the instruction queue becomes greater than or equal to a first threshold value upon detecting the amount of the instructions held in the instruction queue is less than the first threshold value, and
the instruction fetch circuit fetches the instruction from the instruction queue and supplies the instruction to the instruction decoder upon detecting the amount of the instructions held in the instruction queue becomes greater than or equal to the first threshold value.

15. The processing method as claimed in claim 3,
wherein the bubble insertion prohibition information included in the instruction for executing an operation by using the operation result data bypassed from the arithmetic circuit via the first selector is set to indicate that the insertion of the bubble is prohibited, and
wherein the bubble insertion prohibition information included in the instruction for executing an operation without using the operation result data bypassed from the arithmetic circuit is set to indicate that the insertion of the bubble is permitted.

16. The processing method as claimed in claim 11, further comprising:
holding, by an instruction queue, an instruction;
fetching, by an instruction fetch circuit, the instruction held in the instruction queue and supplying, by the instruction fetch circuit, the instruction to the instruction decoder;
determining, by a determination circuit, whether an operation of the instruction supplied to the instruction queue is executed by the arithmetic circuit using the operation result data bypassed from the arithmetic circuit via the first selector; and
holding, by a pre-read queue, a determination result of the determination circuit corresponding to the instruction held in the instruction queue and being updated, by the pre-read queue, in response to the instruction queue being updated,
wherein the instruction fetch circuit supplies a no-operation instruction to the instruction decoder in response to detecting that a head entry of the pre-read queue holds non-use information indicating that the operation result data bypassed from the arithmetic circuit is not used, in conjunction with detecting that all of second and subsequent entries of the pre-read queue hold use information indicating that the operation result data bypassed from the arithmetic circuit is used, and subsequently, in response to detecting that the non-use information is stored in an entry after the second and subsequent consecutive entries of the pre-read queue in which the use information is continuously held, sequentially supplies instructions held in the instruction queue corresponding to the use information held in the head entry and the second and subsequent consecutive entries of the pre-read queue to the instruction decoder.

17. The processing method as claimed in claim 16, wherein the instruction fetch circuit supplies the instruction held in the head entry of the instruction queue to the instruction decoder in response to detecting that the second entry of the pre-read queue holds the non-use information.

18. The processing as claimed in claim 11, further comprising:
selecting, by a third selector, the data to be used in the instruction supplied from the instruction decoder or the operation result data output from the arithmetic circuit based on a selection control signal and outputting, by the third selector, the selected data or selected operation result data to the data holding circuit,
wherein the instruction decoded by the instruction decoder further includes selection information, and
wherein the instruction decoder generates the selection control signal based on the selection information.

19. The processing method as claimed in claim 18, wherein the instruction including the bypass information for causing the first selector to select the operation result data includes the selection information for prohibiting the operation result data from being selected by the third selector.

20. The processing method as claimed in claim 11, wherein the instruction decoder generates a signal including a command to prohibit the operation result data to be bypassed from being stored in the data holding circuit.
